(19) United States
(12) Patent Application Publication
(10) Pub. No.: US 2025/0365589 A1
(43) Pub. Date: Nov. 27, 2025

(54) Near Real Time Wireless Network Outage Detection

(71) Applicant: Apple Inc., Cupertino, CA (US)

(72) Inventors: Ozgur Ekici, Ottawa, Ontario (CA); Thanigaivelu Elangovan, Cupertino, CA (US); Elliot S. Briggs, Carmel, CA (US); Ashley M. Williams, Mountain View, CA (US); Rachid Kachemir, Mountain View, CA (US); Rajesh Ambati, Los Altos Hills, CA (US)

(21) Appl. No.: 18/674,540

(22) Filed: May 24, 2024

(51) Int. Cl. H04W 24/08; H04L 43/0811

(52) U.S. Cl. CPC H04W 24/08; H04L 43/0811

(57) ABSTRACT

An apparatus of a UE is disclosed comprising one or more processors, coupled to a memory, configured to identify a location of the UE, determine a cellular coverage status of the UE as one of connected or limited coverage or no service, identify an MNC of the UE, and send, to a remote server, connectivity status information of the UE comprising the location, the cellular coverage status and the MNC of the UE. The remote server is configured to identify a network outage based on the connectivity status of the UE and a plurality of UEs located in one or more MNCs and send network outage information to the UE and the plurality of UEs associated with one of the MNCs identified with the network outage. The UE can decode the network outage information received from the remote server when the network outage is identified at the server.

### FIELD

Embodiments of the invention relate to wireless communications, including apparatuses, systems, and methods for near real time wireless network outage detection.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) has been the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. In 2015, a study of a new radio access technology began and, in 2017, a first release of Fifth Generation New Radio (5G NR) was standardized.

5G-NR, also simply referred to as 5G or NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible scheduling as compared to current LTE. Consequently, efforts are being made in ongoing developments of NR to take advantage of higher throughputs possible at higher frequencies.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates an example of a control plane protocol stack in accordance with some embodiments.

FIG. 9 illustrates an example of a user plane protocol stack in accordance with some embodiments.

FIG. 10 illustrates example components of a core network in accordance with some embodiments.

FIG. 11 provides an example illustration of network outage of a specific mobile network operator (MNO), according to some embodiments.

FIG. 12 provides an example illustration of a network outage in cellular networks caused by a natural disaster, according to some embodiments.

FIG. 13 provides an example illustration showing the number of online devices (e.g. UEs) for the week of the natural disaster, according to some embodiments.

FIG. 14 provides an example illustration of a power profile for a UE of a regular scan versus a power profile of a reduced scan during a network outage, according to some embodiments.

FIG. 15 provides an example illustration of a user interface displaying a network outage map that shows where no service areas are located for a geographic area, according to some embodiments.

FIG. 16 provides an example illustration of a UE side data collection procedure, according to some embodiments.

FIG. 17 provides an example illustration of a server side data serving procedure, according to some embodiments.

FIG. 18 provides an example illustration of a UE side data consumption procedure, according to some embodiments.

FIG. 19 provides an example illustration of messaging between a UE and a remote server, via a radio access technology (RAT), in accordance with some embodiments.

FIG. 20 illustrates a flow chart of an example of a method for detecting a wireless network outage at a remote server, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium or Memory-Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium-a memory medium as described above, as well as a physical transmission medium, such as a bus, network, and/or other physical transmission medium that conveys signals such as electrical, electromagnetic, or digital signals.

Programmable Hardware Element includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, Internet of Things, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate with UEs as part of a wireless telephone system or radio system, including but not limited Next Generation Node-Bs (gNB or gNodeB) in NR and NG-RAN nodes.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Legacy—The 3rd Generation Partnership Project (3GPP) produces specifications that define 3GPP technologies. 3GPP specifications cover cellular telecommunications technologies, including radio access, core network and service capabilities, which provide a complete system description for mobile telecommunications. 3GPP uses a system of parallel “Releases” that provide developers with a stable platform for the implementation of features at a given point and then allow for the addition of new functionality in subsequent releases. Release 17 was released in 2022. Release 18 (Rel-18), at the time of this disclosure, is nearing release on Jun. 22, 2024, as its specifications have been largely defined. Accordingly, implementations and concepts compatible with Rel-18, or previous Releases, are sometimes referred to herein as “Legacy Releases.” One or more embodiments of the present disclosure may be adopted in future Releases, e.g., Release 19.

Near Real-Time: a time that is longer than instantaneous (e.g. real-time). The near real-time period may be a relatively short period, such as tens of milliseconds, to a relatively long period such as 3 to 4 hours.

Remote Server: a server that is configured to receive information from a UE and send information to the UE. The remote server may be coupled to a base station via a core network. Alternatively, the remote server can be connected to the internet and communicate with the UE via an internet connection to the UE's core network in a mobile network carrier (MNC).

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

The example embodiments may be further understood with reference to the following description and the related appended drawings, wherein like elements are provided with the same reference numerals. The example embodiments relate to apparatuses, systems and method for reducing energy usage by network components, e.g., base stations in wireless communication systems.

The example embodiments are described with regard to communication between a Next Generation Node B (gNB) and a user equipment (UE). However, reference to a gNB or a UE is merely provided for illustrative purposes. The example embodiments may be utilized with any electronic component that may establish a connection to a network and is configured with the hardware, software, and/or firmware to support for reducing energy usage by network components in wireless communication systems. Therefore, the gNB or UE as described herein is used to represent any appropriate type of electronic component.

The example embodiments are also described with regard to a fifth generation (5G) New Radio (NR). However, reference to a 5G NR network is merely provided for illustrative purposes. The example embodiments may be utilized with any appropriate type of network.

Throughout this description various information elements (IEs) are referred to by specific names. It should be understood that these names are only examples and the IEs carrying the information referred to throughout this description may be referred to by other names by various entities.

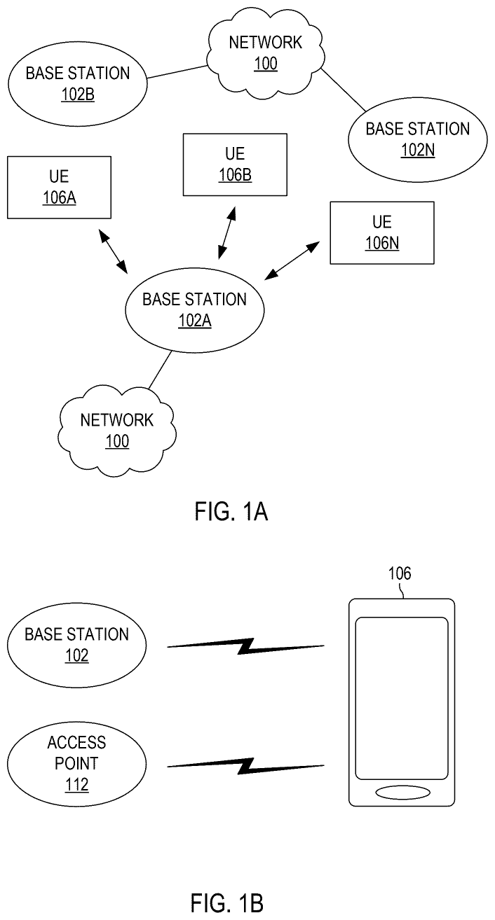

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), a, a network of a mobile network operator (MNO) or a mobile network carrier (MNC) and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

In some embodiments, the base station 102A may select a paging configuration and a PEI configuration for UEs 106. The base station 102A may encode and transmit the paging configuration and the PEI configuration to UEs 106 as part of a registration process. Using the paging configuration, UEs 106 can determine which PO and PF to monitor in a paging cycle. Using the PEI configuration, UEs 106 can determine the radio frame that carries relevant PEI.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

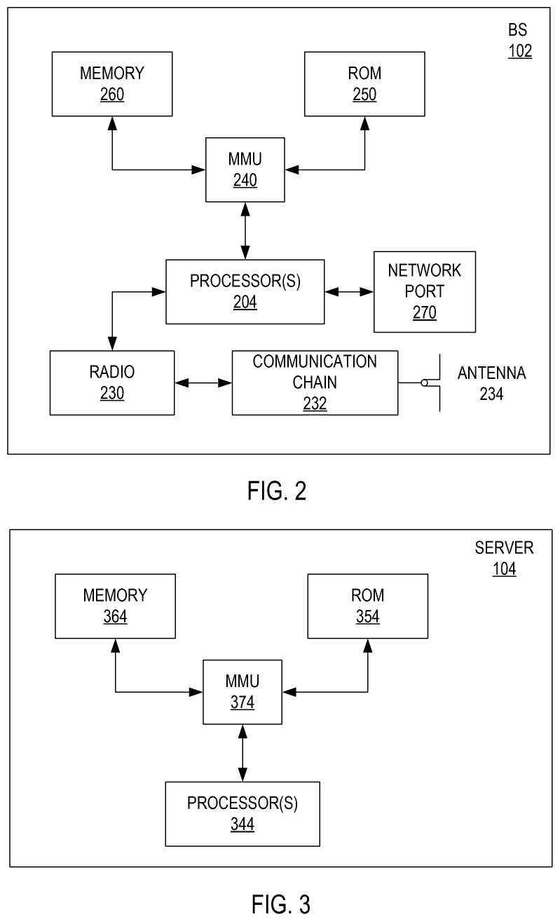

FIG. 2: Block Diagram of a Base Station (gNB)

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the base station 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the base station 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, and UE devices 106 access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

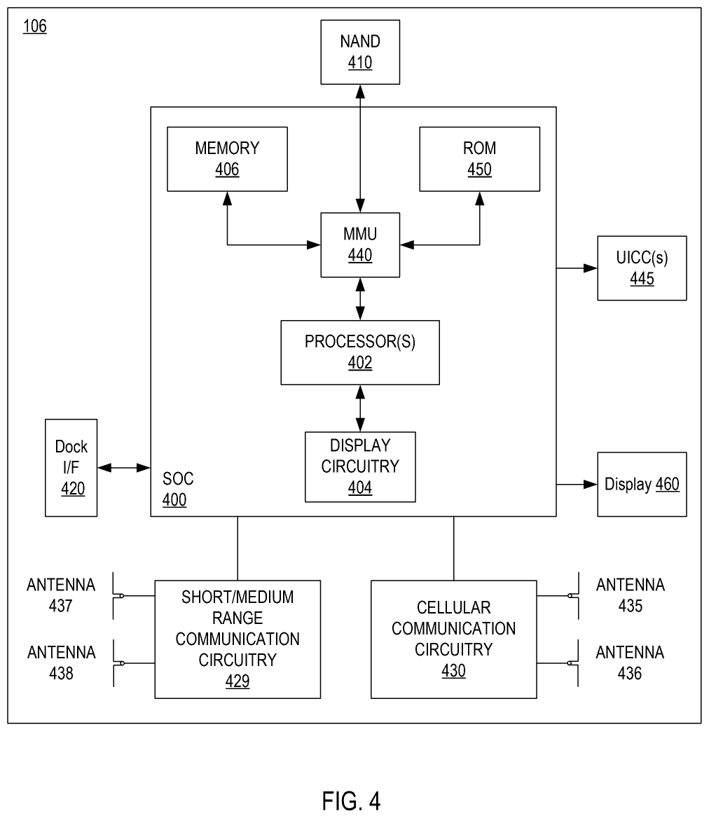

### FIG. 4: Block Diagram of a User Equipment (UE)

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VOLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

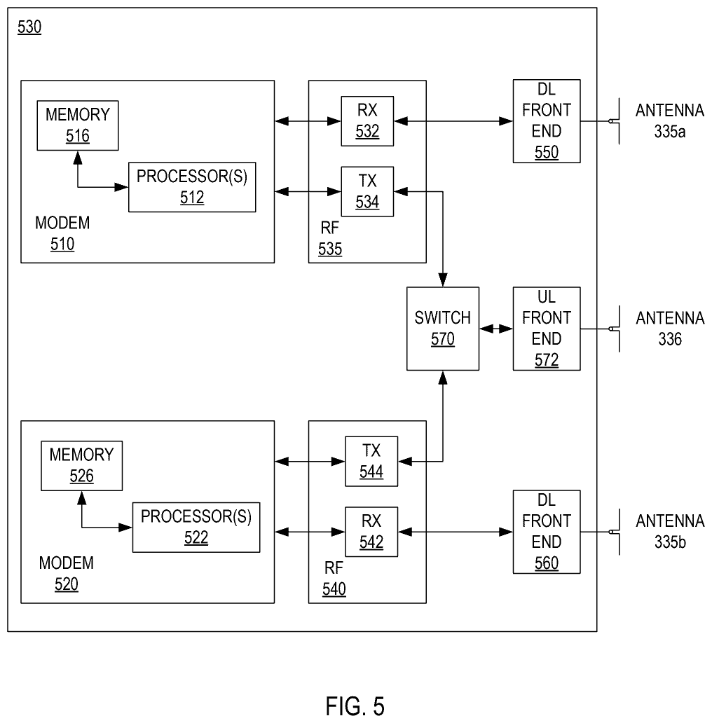

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 535. RF front end 535 may include circuitry for transmitting and receiving radio signals. For example, RF front end 535 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 535, 550, 570, 572, 335a, 335b, and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335a, 335b, and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

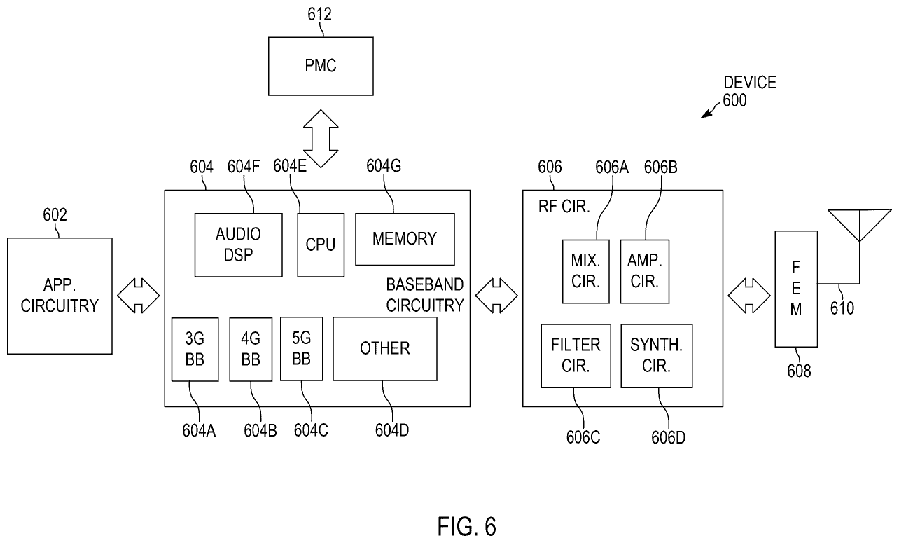

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node 102A. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where, again, it periodically wakes up to listen to the network and then powers down at least portions of the device again. The device 600 may not receive data in this state. In order to receive data, it will transition back to an RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

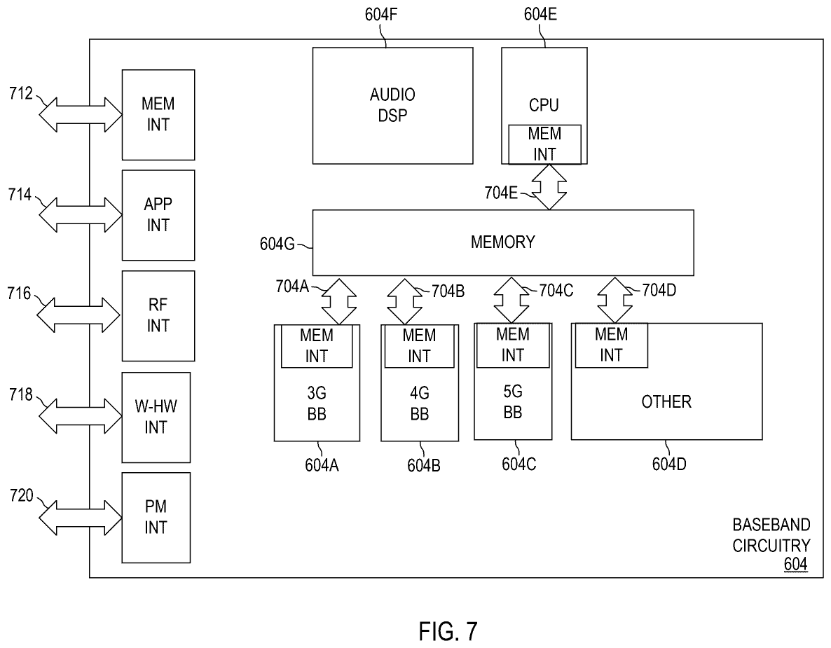

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

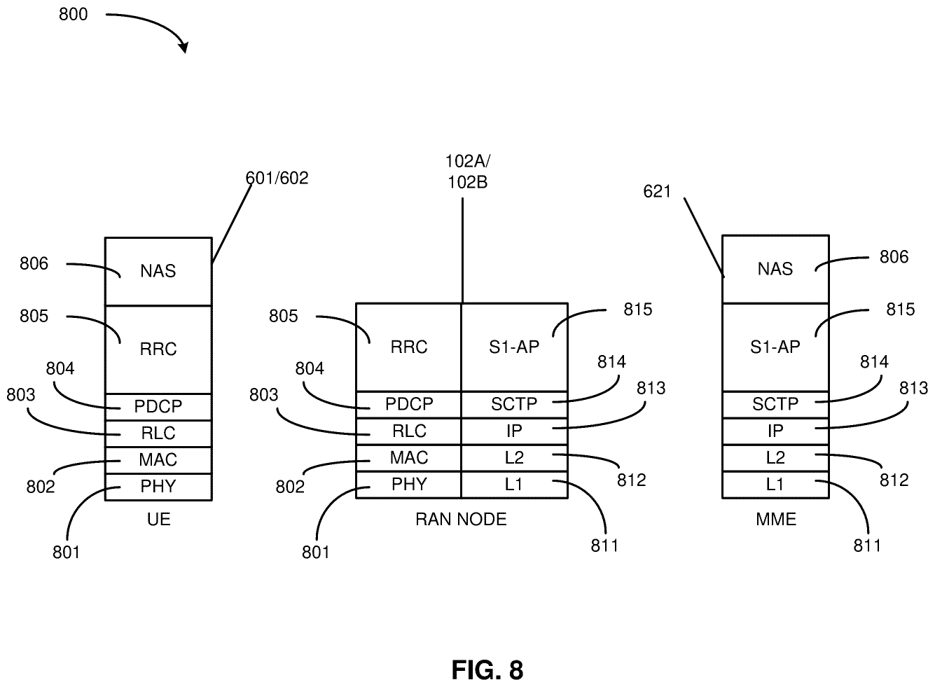

### FIG. 8: Control Plane Protocol Stack

FIG. 8 is an illustration of a control plane protocol stack in accordance with some embodiments. In this embodiment, a control plane 800 is shown as a communications protocol stack between the UE 106a (or alternatively, the UE 106b), the RAN node 102A (or alternatively, the RAN node 102B), and the mobility management entity (MME) 621.

The PHY layer 801 may transmit or receive information used by the MAC layer 802 over one or more air interfaces. The PHY layer 801 may further perform link adaptation or adaptive modulation and coding (AMC), power control, cell search (e.g., for initial synchronization and handover purposes), and other measurements used by higher layers, such as the RRC layer 805. The PHY layer 801 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 802 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 803 may operate in a plurality of modes of operation, including: Transparent Mode (TM), Unacknowledged Mode (UM), and Acknowledged Mode (AM). The RLC layer 803 may execute transfer of upper layer protocol data units (PDUs), error correction through automatic repeat request (ARQ) for AM data transfers, and concatenation, segmentation and reassembly of RLC SDUs for UM and AM data transfers. The RLC layer 803 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 804 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 805 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 601 and the RAN node 102A may utilize a Uu interface (e.g., an LTE-Uu interface) to exchange control plane data via a protocol stack comprising the PHY layer 801, the MAC layer 802, the RLC layer 803, the PDCP layer 804, and the RRC layer 805.

The non-access stratum (NAS) protocols 806 form the highest stratum of the control plane between the UE 601 and the MME 621. The NAS protocols 806 support the mobility of the UE 601 and the session management procedures to establish and maintain IP connectivity between the UE 601 and the P-GW 623.

The S1 Application Protocol (S1-AP) layer 815 may support the functions of the S1 interface and comprise Elementary Procedures (EPS). An EP is a unit of interaction between the RAN node 102A and the network 100. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 814 may ensure reliable delivery of signaling messages between the RAN node 102A and the MME 621 based, in part, on the IP protocol, supported by the IP layer 813. The L2 layer 812 and the L1 layer 811 may refer to communication links (e.g., wired or wireless) used by the RAN node and the MME to exchange information.

The RAN node 102A and the MME 621 may utilize an S1-MME interface to exchange control plane data via a protocol stack comprising the L1 layer 811, the L2 layer 812, the IP layer 813, the SCTP layer 814, and the S1-AP layer 815.

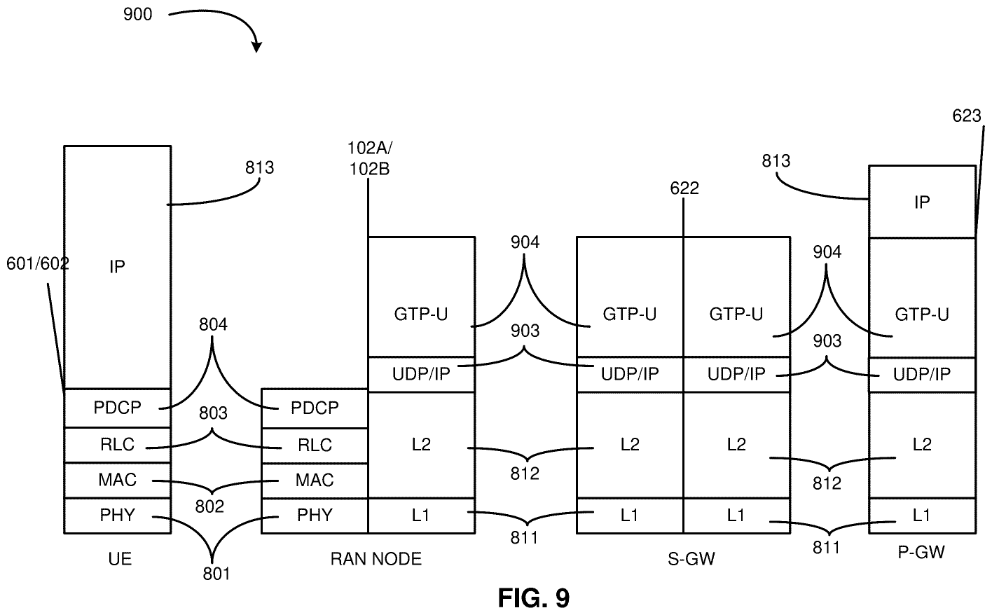

### FIG. 9: User Plane Protocol Stack

FIG. 9 is an illustration of an example of a user plane protocol stack in accordance with some embodiments. In this embodiment, a user plane 900 is shown as a communications protocol stack between the UE 106A (or alternatively, the UE 106B or 106N), the RAN node 102A (or alternatively, the RAN node 102B), the S-GW 622, and the P-GW 623. The user plane 900 may utilize at least some of the same protocol layers as the control plane 800. For example, the UE 601 and the RAN node 102A may utilize a Uu interface (e.g., an LTE-Uu interface) to exchange user plane data via a protocol stack comprising the PHY layer 801, the MAC layer 802, the RLC layer 803, the PDCP layer 804.

The General Packet Radio Service (GPRS) Tunneling Protocol for the user plane (GTP-U) layer 904 may be used for carrying user data within the GPRS core network and between the radio access network and the core network. The user data transported can be packets in any of IPV4, IPv6, or PPP formats, for example. The UDP and IP security (UDP/IP) layer 903 may provide checksums for data integrity, port numbers for addressing different functions at the source and destination, and encryption and authentication on the selected data flows. The RAN node 102A and the S-GW 622 may utilize an S1-U interface to exchange user plane data via a protocol stack comprising the L1 layer 811, the L2 layer 812, the UDP/IP layer 903, and the GTP-U layer 904. The S-GW 622 and the P-GW 623 may utilize an S5/S8a interface to exchange user plane data via a protocol stack comprising the L1 layer 811, the L2 layer 812, the UDP/IP layer 903, and the GTP-U layer 904. As discussed above with respect to FIG. 8, NAS protocols support the mobility of the UE 106 and the session management procedures to establish and maintain IP 813 connectivity between the UE 106 and the P-GW 623.

For the remainder of this disclosure, references to base station (gNB) and user equipment (UE) are assumed to refer to base station (gNB) 102 and user equipment (UE) 106, even though specific reference numerals may be omitted.

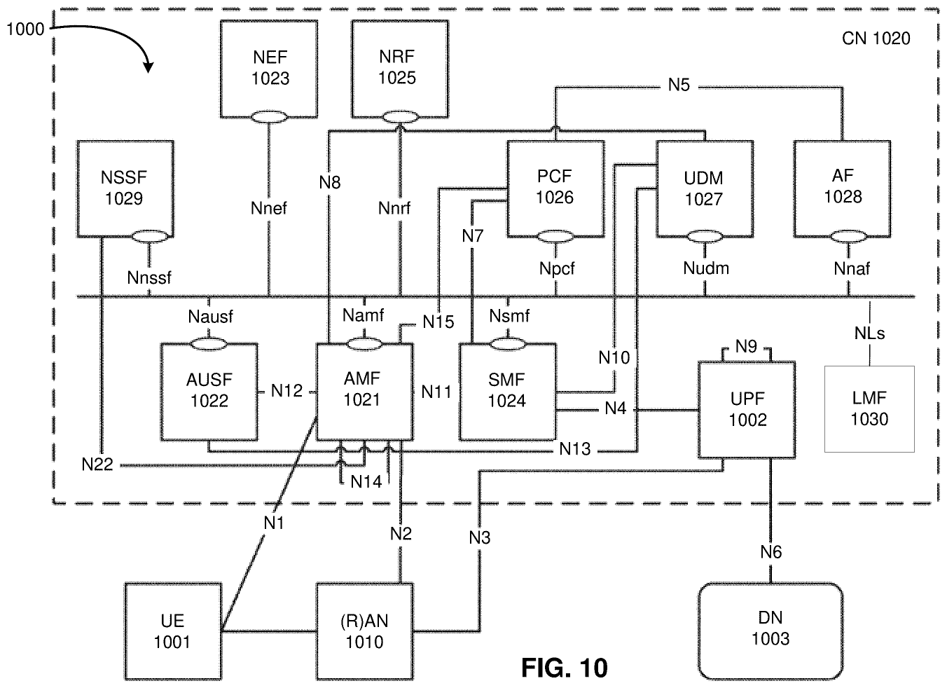

### FIG. 10: Core Network

FIG. 10 illustrates an example architecture of a system 1000 including a core network (CN) 1020 in accordance with various embodiments. The CN 1020 may be a core network for a 5G System (which may be referred to as a 5GC). The system 1000 is shown to include a UE 1001, which may be the same or similar to the UEs 106A, 106B, or 106N discussed previously; a (R)AN 1010, which may be the same or similar to the BSs 102A or 102N discussed previously; and a data network (DN) 1003, which may be, for example, operator services, Internet access, or 3rd party services; and a CN 1020. The CN 1020 may include a number of network functions including an Authentication Server Function (AUSF) 1022; an Access and Mobility Management Function (AMF) 1021; a Session Management Function (SMF) 1024; a Network Exposure Function (NEF) 1023; a Policy Control Function (PCF) 1026; a Network Repository Function (NRF) 1025; a Unified Data Management (UDM) 1027; an Application Function (AF) 1028; a User Plane Function (UPF) 1002; and a Network Slice Selection Function (NSSF) 1029. These network functions may be implemented, in some cases, as virtualized software based functions/services.

The UPF 1002 may act as an anchor point for intra-RAT and inter-RAT mobility, an external packet data unit (PDU) session point of interconnect to DN 1003, and a branching point to support mufti-homed PDU session. A PDU session is a logical connection between the UE and the DN. The UPF 1002 may also perform packet routing and forwarding, perform packet inspection, enforce the user plane part of policy rules, lawfully intercept packets (user plane (UP) collection), perform traffic usage reporting, perform quality of service (QOS) handling for a user plane (e.g., packet filtering, gating, UL/DL rate enforcement), perform Uplink Traffic verification (e.g., Service Data Flows (SDF) to QoS flow mapping), transport level packet marking in the uplink and downlink, and perform downlink packet buffering and downlink data notification triggering. UPF 1002 may include an uplink classifier to support routing traffic flows to a data network, The DN 1003 may represent various network operator services, Internet access, or third party services. DN 1003 may include, or be similar to, application server 104 discussed previously. The UPF 1002 may interact with the SMF 1024 via an N4 reference point between the SMF 1024 and the UPF 1002.

A location management function 1030 can be used to receive location management information from the UE 106 or base station 102 and use the information to determine a location of the UE. Alternatively, the UE may provide the location of the UE to the LMF 1030 using information such as GPS information and triangulation information based on signals received from 3 or more base stations 102N.

The AUSF 1022 may store data for authentication of UE 1001 and handle authentication-related functionality, The AUSF 1022 may facilitate a common authentication frame work for various access types. The AUSF 1022 may communicate with the AMF 1021 via an N12 reference point between the AMF 1021 and the AUSF 1022; and may communicate with the UDM 1027 via an N13 reference point between the UDM 1027 and the AUSF 1022. Additionally, the AUSF 1022 may exhibit an Nausf service-based interface.

The AMF 1021 may be responsible for registration management (e.g., for registering UE 1001, etc.), connection management, reachability management, mobility management, and lawful interception of AMF-related events, and access authentication and authorization. The AMF 1021 may be a termination point for the an N11 reference point between the AMF 1021 and the SMF 1024. The AMF 1021 may provide transport for SM messages between the UE 1001 and the SMF 1024, and act as a transparent proxy for routing SM messages. AMF 1021 may also provide transport for Short Message Service (SMS) messages between UE 1001 and an SMSF (not shown by FIG. 10). AMF 1021 may act as a security anchor function (SEAF), which may include interaction with the AUSF 1022 and the UE 1001, receipt of an intermediate key that was established as a result of the UE 1001 authentication process. Where Universal Subscriber Identity Module (USIM) based authentication is used, the AMF 1021 may retrieve the security material from the AUSF 1022. AMF 1021 may also include a Security Context Management (SCM) function, which receives a key from the SEAF that it uses to derive access-network specific keys. Furthermore, AMF 1021 may be a termination point of a RAN control plane (CP) interface, which may include or be an N2 reference point between the (R)AN 1010 and the AMF 1021; and the AMF 1021 may be a termination point of NAS (NI) signaling, and perform NAS ciphering and integrity protection.

AMF 1021 may also support NAS signaling with a UE 1001 over a non-3GPP Inter-Working Function (N3IWF) interface. The N3IWF may be used to provide access to untrusted entities. N3IWF may be a termination point for the N2 interface between the (R)AN 1010 and the AMF 1021 for the control plane, and may be a termination point for the N3 reference point between the (R)AN 1010 and the UPF 1002 for the user plane. As such, the AMF 1021 may handle N2 signaling from the SMF 1024 and the AMF 1021 for PDU sessions and encapsulate/de-encapsulate packets for IPSec and N3 tunneling, mark N3 user-plane packets in the uplink, and enforce QoS corresponding to N3 packet marking while considering QoS requirements associated with such marking received over N2. N3IWF may also relay uplink and downlink control plane non-access stratum (NAS) signaling between the UE 1001 and AMF 1021 via an N1 reference point between the UE 1001 and the AMF 1021, and relay uplink and downlink user-plane packets between the UE 1001 and UPF 1002. The N3IWF also provides mechanisms for internet protocol security (IPsec) tunnel establishment with the UE 1001. The AMF 1021 may exhibit an Namf service based interface, and may be a termination point for an N14 reference point between two AMFs 1021 and an N17 reference point between the AMF 1021 and a 5G Equipment Identity Register (5G-EIR) (not shown by FIG. 10).

The UE 1001 may need to register with the AMF 1021 in order to receive network services. Registration Management (RM) is used to register or deregister the UE 1001 with the network (e.g., AMF 1021), and establish a UE context in the network (e.g., AMF 1021). The UE 1001 may operate in an RM-REGISTERED state or an RM-DEREGISTERED state. In the RM-DEREGISTERED state, the UE 1001 is not registered with the network, and the UE context in AMF 1021 holds no valid location or routing information for the UE 1001 so the UE 1001 is not reachable by the AMF 1021. In the RM REGISTERED state, the UE 1001 is registered with the network, and the UE context in AMF 1021 may hold a valid location or routing information for the UE 1001 so the UE 1001 is reachable by the AMF 1021. In the RM-REGISTERED state, the UE 1001 may perform mobility registration update procedures, perform periodic registration update procedures triggered by expiration of the periodic update timer (e.g., to notify the network that the UE 1001 is still active), and perform a Registration Update procedure to update UE capability information or to re-negotiate protocol parameters with the network, among others.

The AMF 1021 may store one or more RM contexts for the UE 1001, where each RM context is associated with a specific access to the network. The RM context may be a data structure, database object, etc. that indicates or stores, inter glia, a registration state per access type and the periodic update timer. The AMF 1021 may also store a 5GC mobility management (MM) context that may be the same or similar to the evolved packet services (EPS) Mobility Management (E) MM context discussed previously. In various embodiments, the AMF 1021 may store a CE mode B Restriction parameter of the UE 1001 in an associated MM context or registration management (RM) context. The AMF 1021 may also derive the value, when needed, from the UE's usage setting parameter already stored in the UE context (and/or MM/RM context).

Connection Management (CM) may be used to establish and release a signaling connection between the UE 1001 and the AMF 1021 over the N1 interface. The signaling connection is used to enable NAS signaling exchange between the UE 1001 and the CN 1020, and comprises both the signaling connection between the UE and the AN (e.g., RRC connection or UE-N3IWF connection for non-3GPP access) and the N2 connection for the UE 1001 between the AN (e.g., AN 1010) and the AMF 1021. The UE 1001 may operate in one of two CM states, CM-IDLE mode or CM-CONNECTED mode. When the UE 1001 is operating in the CM-IDLE state/mode, the UE 1001 may have no NAS signaling connection established with the AMF 1021 over the N1 interface, and there may be (R)AN 1010 signaling connection (e.g., N2 and/or N3 connections) for the UE 1001. When the UE 1001 is operating in the CM-CONNECTED state/mode, the UE 1001 may have an established NAS signaling connection with the AMF 1021 over the N1 interface, and there may be a (R)AN 1010 signaling connection (e.g., N2 and/or N3 connections) for the UE 1001. Establishment of an N2 connection between the (R)AN 1010 and the AMF 1021 may cause the UE 1001 to transition from CM-IDLE mode to CM-CONNECTED mode, and the UE 1001 may transition from the CM-CONNECTED mode to the CM-IDLE mode when N2 signaling between the (R)AN 1010 and the AMF 1021 is released.

The SMF 1024 may be responsible for session management (SM) session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 1001 and a data network (DN) 1003 identified by a Data Network Name (DNN). PDU sessions may be established upon UE 1001 request, modified upon UE 1001 and CN 1020 request, and released upon UE 1001 and CN 1020 request using NAS SM signaling exchanged over the N1 reference point between the UE 1001 and the SMF 1024. Upon request from an application server, the CN 1020 may trigger a specific application in the UE 1001. In response to receipt of the trigger message, the UE 1001 may pass the trigger message (or relevant parts/information of the trigger message) to one or more identified applications in the UE 1001. The identified application(s) in the UE 1001 may establish a PDU session to a specific data network name (DNN). The SMF 1024 may check whether the UE 1001 requests are compliant with user subscription information associated with the UE 1001. In this regard, the SMF 1024 may retrieve and/or request to receive update notifications on SMF 1024 level subscription data from the UDM 1027.

The SMF 1024 may include the following roaming functionality: handling local enforcement to apply QOS SLAB virtual Public Land Mobile Network (VPLMN); charging data collection and charging interface (VPLMN); lawful intercept (in VPLMN for SM events and interface to LI system); and support for interaction with external DN for transport of signaling for PDU session authorization/authentication by external DN. An N16 reference point between two SMFs 1024 may be included in the system 1000, which may be between another SMF 1024 in a visited network and the SMF 1024 in the home network in roaming scenarios. Additionally, the SMF 1024 may exhibit the Nsmf service-based interface.

The NEF 1023 may provide means for securely exposing the services and capabilities provided by 3GPP network functions for third party, internal exposure/re-exposure, Application Functions (e.g., AF 1028), edge computing or fog computing systems, etc. In such embodiments, the NEF 1023 may authenticate, authorize, and/or throttle the AFS. NEF 1023 may also translate information exchanged with the AF 1028 and information exchanged with internal network functions. For example, the NEF 1023 may translate between an AF-Service-Identifier and an internal SCC information. NEF 1023 may also receive information from other network functions (NFs) based on exposed capabilities of other network functions. This information may be stored at the NEF 1023 as structured data, or at a data storage NF using standardized interfaces. The stored information can then be re-exposed by the NEF 1023 to other NFs and AFs, and/or used for other purposes such as analytics. Additionally, the NEF 1023 may exhibit an Nnef service-based interface.

The NRF 1025 may support service discovery functions, receive NF discovery requests from NF instances, and provide the information of the discovered NF instances to the NF instances. NRF 1025 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1025 may exhibit the Nnrf service based interface.

The PCF 1026 may provide policy rules to control plane function(s) to enforce them, and may also support unified policy framework to govern network behavior, The PCF 1026 may also implement a front end (FE) to access subscription information relevant for policy decisions in a UDR of the UDM 1027. The PCF 1026 may communicate with the AMF 1021 via an N15 reference point between the PCF 1026 and the AMF 1021, which may include a PCF 1026 in a visited network and the AMF 1021 in case of roaming scenarios. The PCF 1026 may communicate with the AF 1028 via an NS reference point between the PCF 1026 and the AF 1028; and with the SMF 1024 via an N7 reference point between the PCF 1026 and the SMF 1024, The system 1000 and/or CN 1020 may also include an N24 reference point between the PCF 1026 (in the home network) and a PCF 1026 in a visited network, Additionally, the PCF 1026 may exhibit an Npcf service-based interface.

The UDM 1027 may handle subscription-related information to support the network entities' handling of communication sessions, and may store subscription data of UE 1001. For example, subscription data may be communicated between the UDM 1027 and the AMF 1021 via an NS reference point between the UDM 1027 and the AMF. The UDM 1027 may include two parts, an application FE and a UDR (the FE and UDR are not shown by FIG. 10). The UDR may store subscription data and policy data for the UDM 1027 and the PCF 1026, and/or structured data for exposure and application data (including PFDs for application detection, application request information for multiple UEs 1001) for the NEF 1023. The Nadr service-based interface may be exhibited by the UDR 221 to allow the UDM 1027, PCF 1026, and NEF 1023 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 1024 via an NI0 reference point between the UDM 1027 and the SMF 1024. UDM 1027 may also support SMS management, wherein an SMS-FE implements the similar application logic as discussed previously. Additionally, the UDM 1027 may exhibit the Nudm service based interface.

The AF 1028 may provide application influence on traffic routing, provide access to the NCE, and interact with the policy framework for policy control. The NCE may be a mechanism that allows the CN 1020 and AF 1028 to provide information to each other via NEF 1023, which may be used for edge computing implementations. In such implementations, the network operator and third party services may be hosted close to the UE 1001 access point of attachment to achieve an efficient service delivery through the reduced end-to-end latency and load on the transport network. For edge computing implementations, the 5GC may select a UPF 1002 close to the UE 1001 and execute traffic steering from the UPF 502 to DN 1003 via the N6 interface. This may be based on the UE subscription data, UE location, and information provided by the AF 1028. In this way, the AF 1028 may influence UPF (re) selection and traffic routing. Based on operator deployment, when AF 1028 is considered to be a trusted entity, the network operator may permit AF 1028 to interact directly with relevant NFs. Additionally, the AF 1028 may exhibit an Naf service-based interface.

The NSSF 1029 may select a set of network slice instances serving the UE 501. The NSSF 1029 may also determine allowed Network Slice Selection Assistance Information (NSSAI) and the mapping to the subscribed single NSSAI (S-NSSAI) is, if needed. The NSSF 1029 may also determine the AMF set to be used to serve the UE 1001, or a list of candidate AMF(s) 1021 based on a suitable configuration and possibly by querying the NRF 1025. The selection of a set of network slice instances for the UE 1001 may be triggered by the AMF 1021 with which the UE 1001 is registered by interacting with the NSSF 1029, which may lead to a change of AMF 1021. The NSSF 1029 may interact with the AMF 1021 via an N22 reference point between AMF 1021 and NSSF 1029; and may communicate with another NSSF 1029 in a visited network via an N31 reference point (not shown by FIG. 10). Additionally, the NSSF 1029 may exhibit an Nnssf service-based interface.

As discussed previously, the CN 1020 may include a short message service function (SMSF), which may be responsible for SMS subscription checking and verification, and relaying SM messages to/from the UE 1001 to/from other entities, such as an SMS-GMSC/IWMSC/SMS-router. The SMS may also interact with AMF 1021 and UDM 1027 for a notification procedure that the UE 1001 is available for SMS transfer (e.g., set a UE not reachable flag, and notifying UDM 1027 when UE 1001 is available for SMS).

The CN 1020 may also include other elements that are not shown by FIG. 10, such as a Data Storage system/architecture, a 5G-EIR, a Security Edge Protection Proxy (SEPP), and the like. The Data Storage system may include a Structured Data Storage Network Function (SDSF), air Unstructured Data Storage Function (UDSF), and/or the like. Any network function (NF) may store and retrieve unstructured data into/from the UDSF (e.g., UE contexts), via N18 reference point between any NF and the UDSF (not shown by FIG. 10), Individual NFs may share a UDSF for storing their respective unstructured data or individual NFs may each have their own UDSF located at or near the individual NFs. Addition-ally, the UDSF may exhibit an Nudsf service-based interface (not shown by FIG. 10). The 5G-EIR may be an NF that checks the status of permanent equipment identifier (PEI) for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 10 for clarity. In one example, the CN 1020 may include an Nx interface, which is an inter-CN interface between a mobility management entity (MME) and the AMF 1021 in order to enable interworking between CN 1020 and a CN in a 4G system. Other example interfaces/reference points may include an N5G-EIR service-based interface exhibited by a 5G-EIR, an N27 reference point between the NRF in the visited network and the NRF in the home network; and an N31 reference point between the NSSF in the visited network and the NSSF in the home network.

### Cellular Network Outage

A UE's 106 connection to a wireless network 1020 can be disrupted for a number of reasons. When a disruption occurs, the UE 106 will attempt to regain a connection with the network. Referring again to FIG. 1A, a UE 106 (generically referring to any of UEs 106A to 106N) can communicate with a base station 102A. The base station 102A can have a connection to a network 100. The connection can be wired connection, such as a fiber optic connection. The network 100 can be a 5G core network, such as 5G CN 1020 illustrated in FIG. 10. The area that the base station 102A covers is typically referred to as a “cell”. However, the terms “base station” and “cell” are sometimes used interchangeably. The base station that the UE 106 is connected with may have a downlink signal that is received at the UE 106 from the base station with the highest signal power of any neighbor cells 102B, . . . to 102N. Alternatively, the 5G core network (1020, FIG. 10) may assign the UE to connect to a specific base station for any number of reasons.

When a UE 106 travels between cells, the UE 106 can measure neighboring cells (e.g. base station 102B, . . . 102N) and report the measurements to the network 1020. The network 1020 can then instruct the UE to perform a handover from having a wireless connection with a first cell (e.g. 102A) to a second cell (e.g. 102B). The time period for a handover to occur in a 5G network is on the order of tens of milliseconds a time period that is typically not noticed by an end user of the UE.

However, if a neighbor cell is not available, if a radio link failure occurs between the UE 106 and the base station 102B, or if the base stations 102A . . . 102N in both the serving cell and the neighbor cell have lost a connection with the 5G CN 1020, or if the CN 1020 has lost a connection with a mobile network operator (MNO), then the UE can lose its connection with the cellular network for longer periods that may quickly be noticed by the end user.

The UE 106 may not be able to determine the actual reason for the failure of the UE to connect to the 5G CN 1020 via one or more of the base stations 102A to 102N. The lack of information at the UE 106 regarding the lost connection can be detrimental to the UE 106. The UE 106 may use unnecessary resources to attempt to reconnect with a base station 102A, . . . 102N including but not limited to battery usage. The UE can use a relatively high amount of power scanning for a signal from a base station in order to reconnect. When the signals from the base stations 102A, . . . 102N are weak or nonexistent, it can use the UE to reduce or drain its battery in a relatively short amount of time.

Therefore, the ability of the UE 106 to identify one or more reasons why a connection with a cellular network is not available to the UE can assist the UE in adaptability and flexibility of reconnecting to the 5G CN 1020 while minimizing unnecessary attempts to reconnect to the network that may use available wireless bandwidth and reduce battery usage. The present disclosure provides novel and non-obvious technical solutions applicable to determine, at a remote server, when a wireless network outage has occurred. For example, the present disclosure provides unique technical solutions on (1) identifying when a network outage has occurred; (2) Determining whether network the outage is carrier agnostic; (3) sending a network outage message to UEs affected by the network outage; and (4) enabling UEs to reduce power consumption during the network outage.

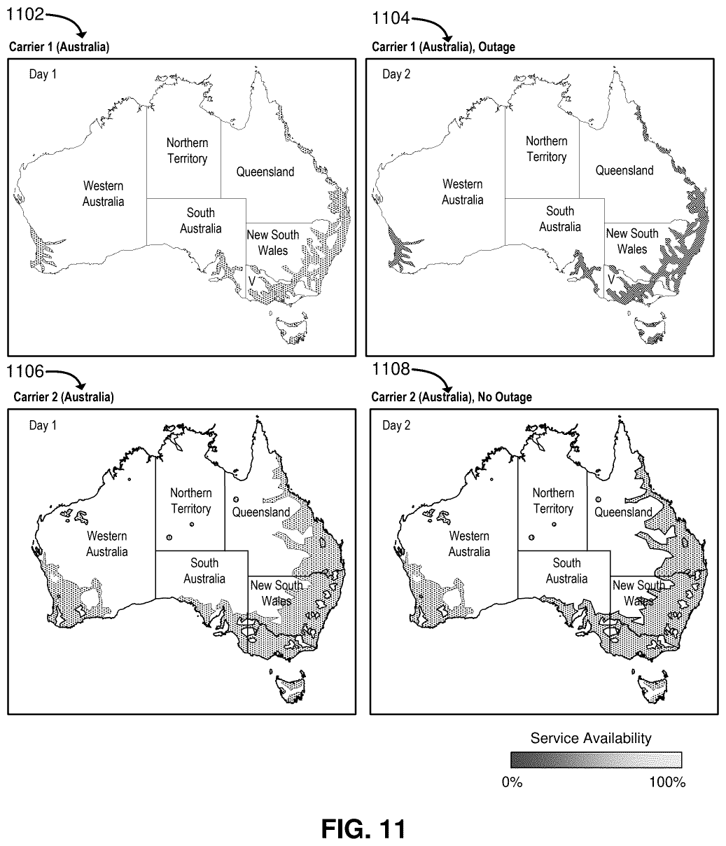

### FIGS. 11 to 13: Examples of Carrier and Network Outages

A mobile network operator (MNO), also known as a wireless service provider, a wireless carrier, a cellular company, or a mobile network carrier, is a provider of wireless communication services. The MNO may be privately owned or publicly owned by a municipality, city, county, state, national government, or other type of public entity. The MNO can own or control all of the elements necessary to deliver services to the UE end-user. This can include radio spectrum allocation, wireless network infrastructure, and other necessary components. Examples of some of the largest MNOs in the United States include AT&T, Verizon, and T-Mobile US. Other countries also use publicly or privately owned MNOs. An end-user typically contracts with a single MNO to provide wireless service to one or more UEs. Accordingly, if a wireless connection outage occurs at a UE, it can be difficult for the UE or the end-user to determine if the outage is with the UE's MNO or is more widespread.

For instance, FIG. 11 provides a hypothetical example illustration of a network outage of a specific MNO in a country, such as Australia, that uses multiple MNOs. FIG. 11 provides an example illustration showing the difference in service availability for two different MNOs (e.g. Carrier 1 and Carrier 2) in a country, such as Australia, in another hypothetical example. In this example, both the Carrier 1 and Carrier 2 MNO provided near 100% service availability on Day 1, as shown in 1102 and 1106, respectively. On Day 2, Carrier 2 continued to provide near 100% service availability, as shown in 1108. However, the Carrier 1 MNO had a network outage, where 10 million Carrier 1 users experienced a network outage for 10 hours on Day 2, as shown in 1104.

When no information is available to end-users, then the end-users may attempt to determine what was occurring during the outage. It is possible that, with the availability of rapid communication on the internet, news sources may investigate outages and determine that cellular connections are down in cities across the United States. However, the true scope and cause of the failure may not be known. The lack of information available to the end-users can lead to the rapid spread of misinformation. News sources and social media sites may posit whether a terrorist attack or terrorist computer hack may have interrupted cellular communication in the United States across multiple MNOs.

However, in a typical network outage, after hours of stress and concern, the cause of the widespread outage is typically determined to be a much more benign cause. For example, the outage may be caused by a more common situation, such as a software problem that can occur when a large MNO attempts to update its software. Because the end-users were not aware of the cause of the outage, or scope of the problem, it can result in the spread of misinformation. And the end-users UEs can suffer from significant power drain as the UEs repeatedly attempted to find and connect to a functioning base station within the network without success during the outage. The ability for end-users to determine when an outage has occurred on their network, and for the end-user's UEs to identify when a network outage has occurred can be very beneficial.

As shown in the example illustrations of FIGS. 11 to 13, network outages can occur that may be carrier (e.g. MNO or MNC) specific. Alternatively, network outages caused by external factors, such as natural disasters, can be carrier agnostic that can affect multiple different MNOs and/or MNCs. in accordance with some embodiments, a novel and carrier agnostic near-real-time network outage detection methodology is disclosed. The ability to provide carrier (e.g. MNO or MNC) agnostic network outage detection enables the methodology to identify whether a network outage is for a specific MNO or MNC, or a number of different MNOs or MNCs, thereby enabling the methodology to identify whether the cause may be an external factor, such as a natural disaster, or something specific to a single or few MNOs or MNCs. In addition, end users can be informed that the end user is experiencing a network outage, and the cause of the problem is not the end-user's UE. The end-user can also be informed the scope of the outage (e.g. a small network outage in a specific MNO or MNC, a widescale network outage for a specific MNO, or a network outage across multiple MNOs).

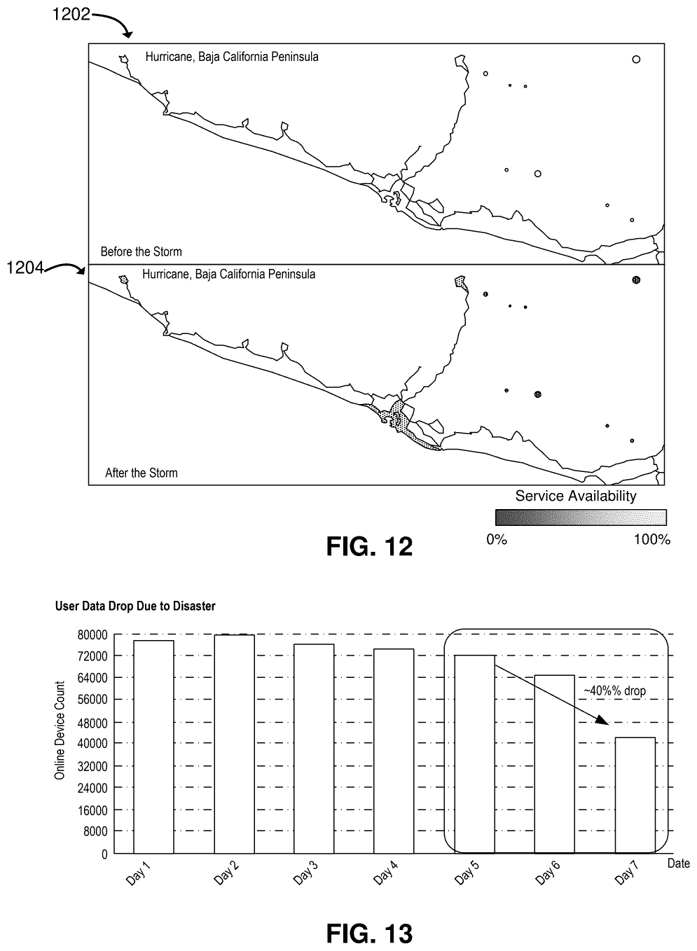

FIG. 12 provides another example illustration of a network outage in multiple MNOs caused by a natural disaster. In this hypothetical example, a Hurricane may hit a hurricane prone shoreline, such as the Baja California Peninsula in Mexico. Prior to the storm, the cellular networks of multiple MNOs provided near 100% service availability, as shown in 1202. However, after the storm, service availability was significantly degraded across the Baja California Peninsula, as shown in 1204.

FIG. 13 provides an example illustration showing the number of online devices (e.g. UEs), for the week of the natural disaster, which were connected to the multiple MNOs. In the days before the hurricane, between approximately 78,000 and 71,500 users were online. However, when a hurricane strikes on Day 5 in this example, the number of online users after Day 5 is significantly decreased on Days 6 and 7. In this hypothetical scenario, the number of online devices, across a number of different MNOs, decreased by about 40% after the natural disaster.

In some embodiments, cellular network availability (or the lack thereof) can be detected via post processing of crowd sourced location data from end users' UEs. The location based user data can be periodically collected at a remote server. The location based user data can be used for a number of purposes, including to assess a traffic jam on a road or highway, to identify road and street closures due to construction or an accident, or to determine the popularity of a business at a given time (e.g. the number of customers at a coffee shop at 9 AM relative to the number of customers in the coffee shop at 2 PM). The data collected can include the UE's mobile country code (MCC) and the mobile network carrier (MNC). An MNC is used to separate a network from within a country, and is combined with the MCC to uniquely identify a mobile subscriber's network. The MNC and the MCC can be obtained from a UE's international mobile subscriber identity (IMSI). The MCC is the first 3 digits of the IMSI. The MNC is the next 2 or 3 digits in the IMSI. The digits following the MNC in the IMSI is the mobile subscriber identification number (MSIN) associated with the subscriber identification module (SIM) card in the UE. The IMSI is used by any UE in a mobile network that interconnects with other networks. In the present case, the MSIN can be stripped off to provide anonymity to the end-users' location based user data.

In accordance with some embodiments, a cellular network outage can be detected at the server side, using the location based user data at the remote server. For example, when a number of online users drops at a rate faster than a threshold amount. Or when a number of UEs sending a “cellular service is not available” message significantly increases in a given geographic area, then it can be determined that a network outage may have occurred in one or more MNOs. This will be discussed further in the proceeding paragraphs.

In accordance with some embodiments, a network outage detection methodology is disclosed. The methodology comprises: a plurality of UEs, each periodically sending connectivity status information to a remote server. The connectivity status can include one or more of: (1) A serving carrier information in a given area defined by the MCC and the MNC; (2) an explicit signal that the UE is not connected to the carrier (e.g. no serving carrier); (3) an explicit signal that the UE is in an “Emergency Only” state or not. Each UE can be configured to send the connectivity status information with a predetermined frequency, such as once ever 10 minutes, 30 minutes, 60 minutes, 120 minutes, or another desired repetition rate.

The connectivity status information from the plurality of UEs at the remote server can be processed to determine network outage information comprising one or more of: (1) UE connectivity performance, which can be evaluated within a defined geographic area (e.g. city level, county level, state level, or country level) connectivity at a predefined frequency (e.g. once every 10 minutes, 15 minutes, 30 minutes, 60 minutes, 120 minutes) or another predefined frequency; (2) UE connectivity performance, which can be evaluated per MNC in the defined geographic area at the predefined frequency; (3) a change in an amount of data collected in the defined geographic area at the predefined frequency from the plurality of UEs has changed by an amount that is more than a threshold amount; or (4) a change in a number of the plurality of UEs in the defined geographic area at the predefined frequency that are sending the explicit “no service” signal has changed by an amount that is more than a threshold amount.

In one example embodiment, the connectivity status information from the plurality of UEs at the remote server can be processed to determine when the change in the amount of data collected in the defined geographic area at the predefined frequency has changed by an amount that is more than the threshold amount. For example, in Santa Cruz County there may typically be 250,000 UEs that send connectivity status information to the remote server once per hour. However, the processed connectivity status information at the remote server may show that the number of UEs that send connectivity status information to the remote server has decreased to 100,000, a more than 50% decrease. The threshold level may be 50%. Accordingly, the more than 50% decrease may trigger an outage-detection procedure at the remote server.

In another example, the number of UEs sending a “no service” signal in a defined geographic area, such as Santa Cruz county, may typically be around 2,000 devices per hour. However, the processed connectivity status information at the remote server may show that the number of UEs that send the “no service” signal may increase over one or more hours to 100,000 UEs sending the “no service” signal to the remote server. The more than 50× increase in “no service” signal can be greater than the threshold level and can trigger the outage detection procedure at the remote server.

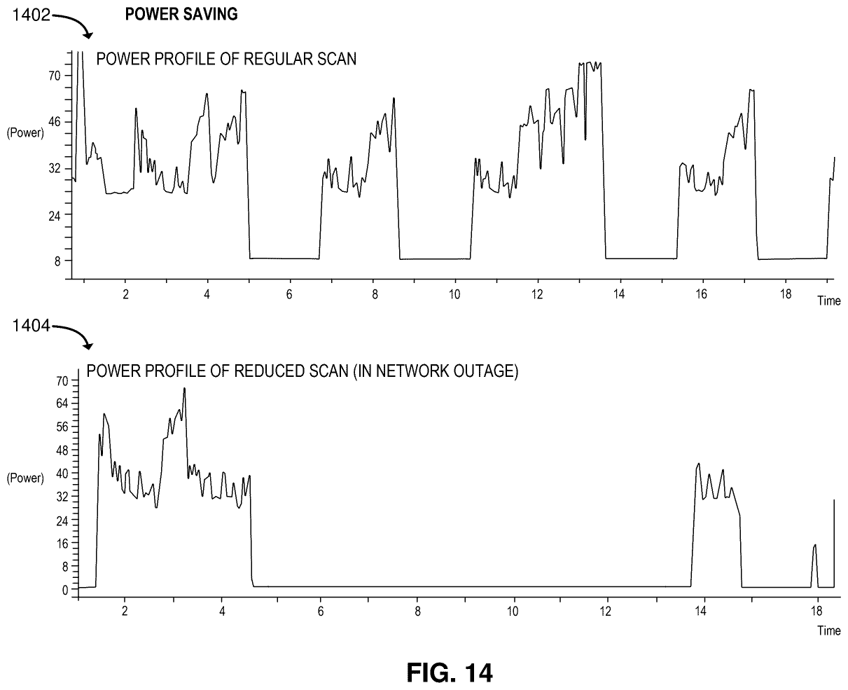

### FIG. 14: Reduced Power and Network Outage Information

When the outage detection procedure is triggered at the remote server for a certain area (e.g. the defined geographic area) via the crowd sourced connectivity status information from the plurality of UEs, the network outage information can be relayed back to one or more of: (1) UEs that have Wi-Fi connectivity but no cellular service within the defined geographic area; (2) a UE that is about to enter the defined geographic area; or (3) the plurality of UEs using peer to peer communication, such as sidelink communication, or another type of peer to peer communication.

Upon receiving the network outage information, the plurality of UEs can reduce their cellular system scan periodicity to save power. For example, the UE may reduce the periodicity at which it scans for an available base station by periodically measuring a received signal strength indicator (RSSI) at selected frequencies. In one embodiment, FIG. 14 provides an example illustration of a power profile for a UE of a regular scan 1402, showing power usage over time, versus a power profile of a reduced scan 1404 during a network outage. As shown in 1404, less power is used over time by a UE when the UE is notified of a network outage and reduces its scan rate. By reducing the scan periodicity during a known cellular outage, lab measurements have shown significant battery savings for a UE.

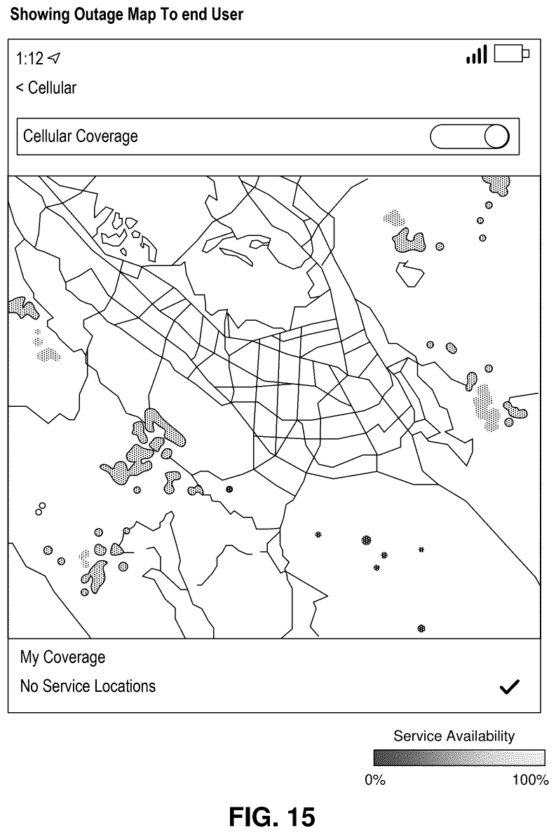

In addition, the network outage information can be used, at one or more of the plurality of UEs to graphically illustrate a network outage map to the end user on the one or more UEs, or another device that may be connected to the internet, showing the end user where the no service areas are geographically located using a user interface. In one embodiment, FIG. 15 provides an example illustration of a user interface displaying a network outage map that shows where the no service areas are located for a geographic area, such as Santa Cruz County. This example is not intended to be limiting. Other applications, including existing applications such as a mapping application, may also be used to display network outage information.

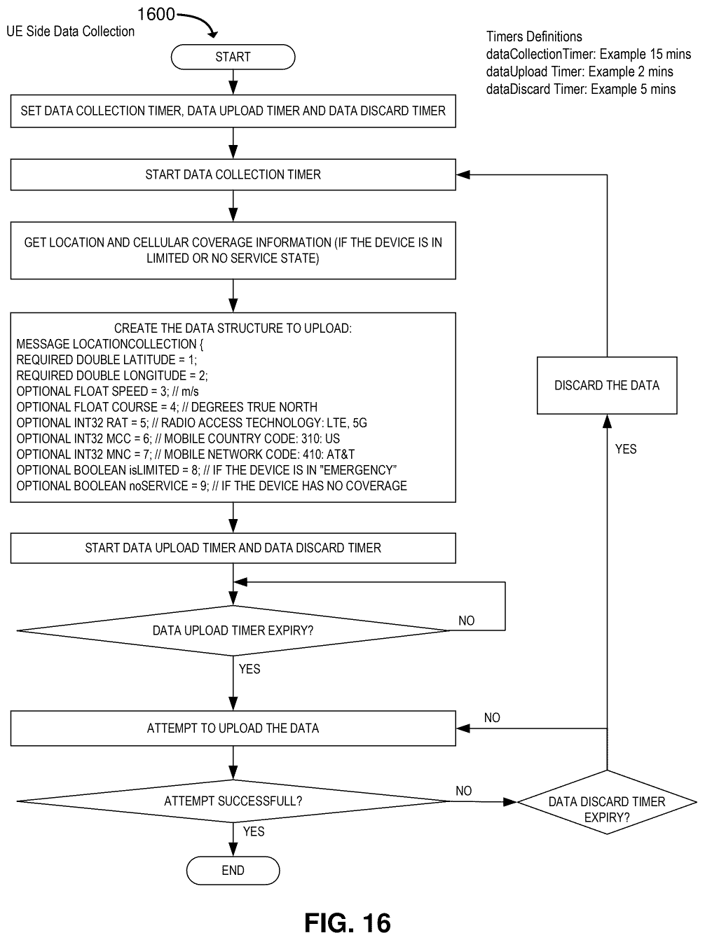

### FIGS. 16 to 18: Connectivity Status Collection, Processing, and Outage Reporting Procedures

FIG. 16 provides an example illustration of a UE side data collection procedure, in accordance with some embodiments. The procedure shown in FIG. 16 may be used in conjunction with any of the systems, methods, or devices illustrated in the Figures, among other devices. In various embodiments, some of the procedure elements shown may be performed concurrently, in a different order than shown, or may be omitted. Additional procedure elements may also be performed as desired.

In accordance with an embodiment, the UE side data collection procedure 1600 can include three separate timers: a data collection timer, set to a time of 15 minutes, a data upload timer, set to 2 minutes, and a data discard timer, set to 5 minutes. These times are not intended to be limiting. Other times may be used to provide a desired data collection at the UE. At the start of the process, the three timers' times are set. The data collection timer is then started. This provides a time period for the data to be aggregated. Next, the location and cellular coverage information is obtained. In one example, this information may only be obtained if the UE is in a limited state (e.g. an “Emergency” state, or a no service state. The data structure is then created at the UE to upload. The data structure can contain the latitude and longitude of the UE, the speed of the UE, the direction of the UE, the type of radio access technology (RAT) that the UE is using to connect to a base station (BS), such as fourth generation (4G), long term evolution (LTE), or a fifth generation (5G) version of the third generation partnership project (3GPP) standard, the MCC (e.g. US), and MNC (e.g. AT&T or Verizon or T-Mobile, etc.), and an indication of the UE is in an “Emergency” state with the RAT or if the UE has no coverage with the RAT. The UE can then start the data upload timer and the data discard timer. When the data upload timer expires, then the UE can attempt to upload the aggregated data in the data structure to the remote server. The data may be uploaded via another RAT, such as via a Wi-Fi or Bluetooth connection to the internet. The UE may also move to an area where there is cellular service to connect to the UE's MNO, and upload the data at the aggregated data at that time. If the UE does have a wireless data connection via a 3GPP 4G, LTE, or 5G connection with a base station, the UE can transmit the data to the base station, and the data can be conveyed to the remote server. If the UE does not have coverage, and the data is discarded, then the UE may upload a notice, such as “no coverage during this time”. If the data is successfully uploaded, then the procedure 1600 will end. If the data is not successfully uploaded, then the data discard timer is checked to see if it has expired. If it has, then the data is discarded and new data is collected to ensure that the data is not older than the data discard timer. The procedure 1600 is then repeated in an attempt to upload the new data.

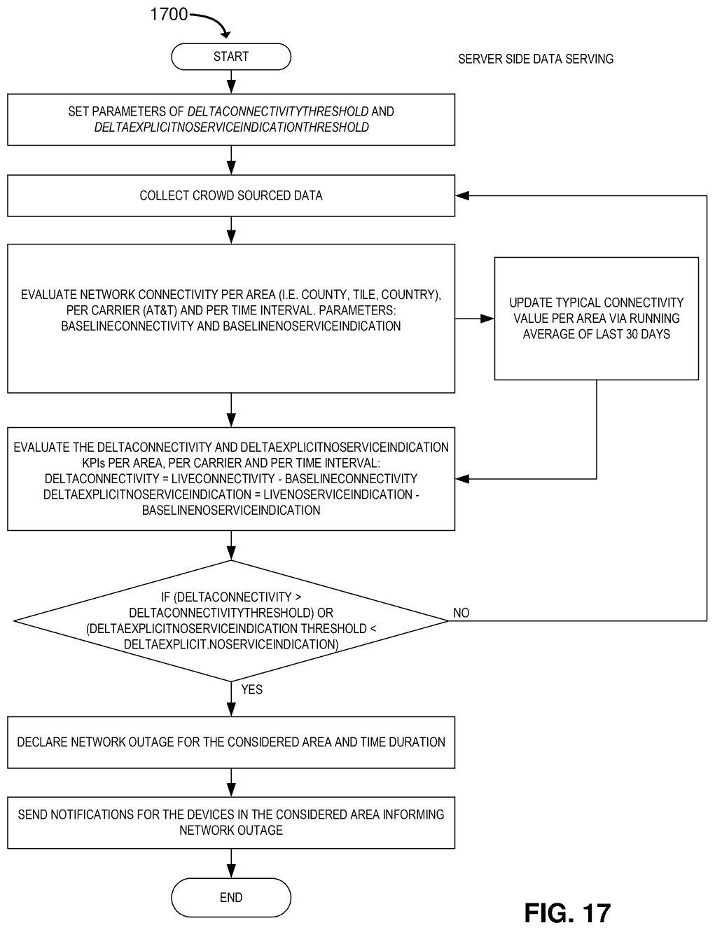

FIG. 17 provides an example illustration of a server side data serving procedure, in accordance with some embodiments. The procedure shown in FIG. 17 may be used in conjunction with any of the systems, methods, or devices illustrated in the Figures, among other devices. In various embodiments, some of the procedure elements shown may be performed concurrently, in a different order than shown, or may be omitted. Additional procedure elements may also be performed as desired.

In accordance with an embodiment, the server side data serving procedure 1700 can set parameters of a delta connectivity threshold value and a delta explicit no service indication threshold value. The server can then collect crowd sourced data from a plurality of UEs. The crowd sourced data can include the connectivity status information as previously discussed.

The server can then evaluate network connectivity per area (e.g. county, tile, or country) per MCC (e.g. AT&T) and per time interval (e.g. 10, 20, 30, 60, 90, or 120 min.) or another desired time interval. The server can determine a baseline connectivity rate and a baseline no service indication. For example, the time interval may be set to 4 hours. The server can determine that the overall connectivity in Cupertino between 12 PM and 4 PM is 99%. For AT&T, the overall connectivity in Cupertino is 98% between 12 PM and 4 PM. For T-Mobile, the overall connectivity in Cupertino is 97% between 12 PM and 4 PM. For Verizon, the overall connectivity in Cupertino is 99% between 12 PM and 4 PM. The typical connectivity value per area can be updated to provide a running average, such as a 30 day running average for the selected time period (e.g. between 12 PM and 4 PM).

The server can then evaluate the delta network connectivity and delta explicit no service indication key performance indicators per area, per carrier and per time interval. The delta connectivity can equal the live connectivity minus the baseline connectivity. Similarly, the delta explicit no service indication can equal the live no service indication minus the baseline no service indication. The baseline values can be obtained from the running average value, such as the 30 day running average, as illustrated in FIG. 17.

If the delta connectivity value is greater than the delta connectivity threshold value, or the delta explicit no service indication threshold value is less than the delta explicit no service indication value, then the server can declare a network outage for the considered area and time duration. The server can then send notifications for the plurality of UEs in the considered area, informing them of the network outage. If the delta connectivity value is not greater than the delta connectivity threshold value, or the delta explicit no service indication threshold value is greater than the delta explicit no service indication value, then the server can collect crowd sourced data and proceed through the server side data serving procedure again, as illustrated in FIG. 17.

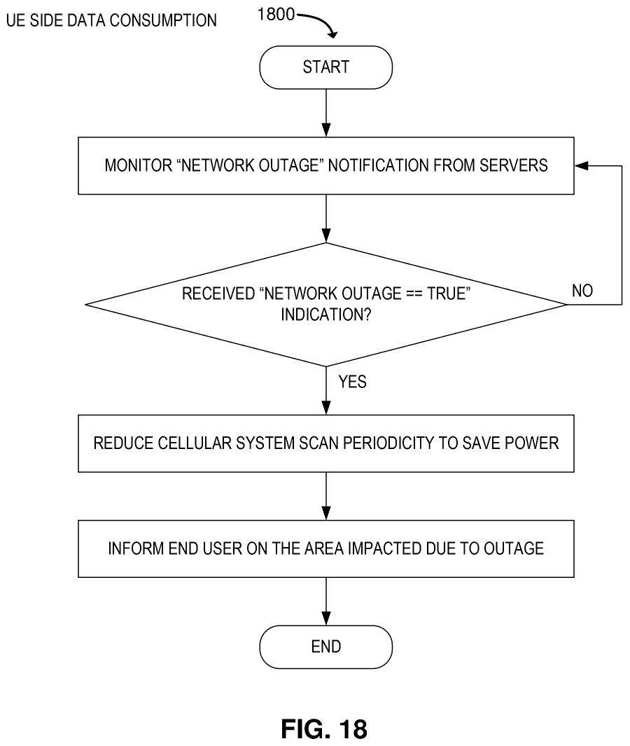

FIG. 18 provides an example illustration of a UE side data consumption procedure, in accordance with some embodiments. The procedure shown in FIG. 18 may be used in conjunction with any of the systems, methods, or devices illustrated in the Figures, among other devices. In various embodiments, some of the procedure elements shown may be performed concurrently, in a different order than shown, or may be omitted. Additional procedure elements may also be performed as desired.

In accordance with an embodiment, the UE side data consumption procedure 1800 comprises monitoring a “network outage” notification from the remote server. If the network outage notification received indication is equal to “true”, then the UE can reduce its cellular system scan periodicity, as previously discussed, to save power consumption at the UE as the UE attempts to connect with the network. The UE can provide a notification to the end user on the area impacted due to the outage. For example, the UE may use a UI as previously discussed, and illustrated in FIG. 15, to inform the end user regarding the network outage. Additional information may also be provided to the UE and end-user. For example, as part of the network outage notification, the server can provide information regarding whether the network outage is for a single MNO or multiple MNOs.

The network outage notification can also provide information regarding how long the network outage has lasted. For example, an end user may awake to a notification that a network outage has occurred, that it has lasted for 6 hours, and that includes multiple MNOs. Based on that information, the end user can use a Wi-Fi connection to quickly determine if a natural disaster has occurred that may have caused all of the MNOs to have a network outage simultaneously.

Alternatively, the end user may awake to a notification that a network outage occurred 15 minutes ago, and it is only for the end user's MNO. The end user can then assume that the network outage may not last long, and continue about their day, while knowing that their UE will not be drained of power due to the network outage.

In some embodiments, an apparatus of a user equipment (UE) 106 is disclosed. The apparatus comprises one or more processors 402, 604, coupled to a memory 406, 604G, configured to: identify a location of the UE 106; determine a cellular coverage status of the UE as one of connected or limited coverage or no service; and identify a mobile network carrier (MNC) 100 of the UE. The one or more processors are further configured to attempt to send, for a selected period of time, to a remote server, connectivity status information of the UE comprising the location of the UE, the cellular coverage status of the UE, and the MNC of the UE. The remote server 103 is configured to identify a network outage based on the connectivity status of the UE and a connectivity status of a plurality of UEs located in one or more MNCs and send network outage information to the UE and the plurality of UEs associated with one of the one or more MNCs identified with the network outage. The one or more processors 604 are further configured to decode, at the UE, the network outage information received from the remote server when the network outage is identified at the server.

In some embodiments, the connectivity status information of the UE further comprises one or more of: a latitude of the UE, a longitude of the UE; a speed (velocity) of the UE; a direction (e.g. North) of the UE; a radio access technology (RAT) of the UE used to send the connectivity status information; or a mobile country code (MCC) of the UE.

In some embodiments, the RAT is one of a third generation partnership project (3GPP) fourth generation (4G) RAT, a 3GPP long term evolution (LTE) RAT, a 3GPP fifth generation (5G) RAT, a Wi-Fi RAT, a Bluetooth RAT, or a Sidelink RAT.

In some embodiments, the one or more processors, 406 or 604, are further configured to attempt to send the connectivity status information of the UE to the remote server for a period of a data upload timer.

In some embodiments, the one or more processors 406 are further configured to: start a data collection timer prior to identifying the location of the UE; determine the cellular coverage status of the UE; determine the location of the UE; create a data structure comprising the connectivity status information of the UE; start a data upload timer and a data discard timer; attempt to upload the connectivity status information after the data upload timer has expired; and discard the connectivity status information when the data discard timer expires before the connectivity status information is uploaded and start the data collection timer again.

In some embodiments, the one or more processors 406 are further configured to: set the data collection timer to a period of one of 5 minutes, 10 minutes, 15 minutes, or 30 minutes; set the data upload timer to a period of one of 1 minute, 2 minutes, 4 minutes, 6 minutes, or 8 minutes; and set the data discard timer to a period of one of 2 minutes, 5 minutes, 7 minutes, or 10 minutes. These example time periods for the timers are not intended to be limiting. Other timer periods can be selected based on system needs and data collection needs.

In some embodiments, the one or more processors 406 are further configured to monitor for the network outage information from the remote server. The one or more processors are further configured to reduce a scan periodicity of the UE 106 to detect a base station in the MNC 100 of the UE when the network outage information is decoded at the UE.

In some embodiments, the one or more processors 406 are further configured to display an area impacted by the network outage using the network outage information.

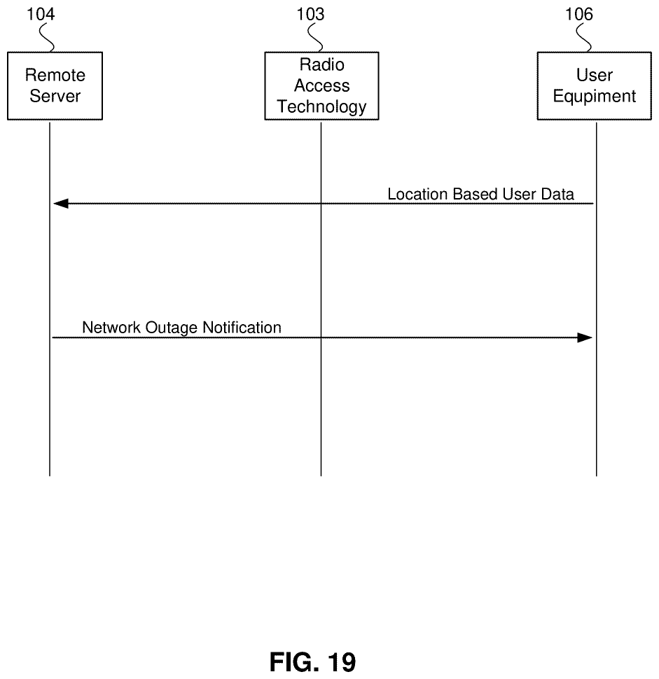

### FIG. 19: UE to Remote Server Messaging

FIG. 19 provides an example illustration of messaging between a UE 106 and a remote server 104, via a radio access technology (RAT) 103 in accordance with some embodiments. As previously discussed, the UE 106 can send Location Based User Data, such as the data structure illustrated in FIG. 16, to a remote server 104. The remote server may be an over the top (OTT) server, or another type of server. Since the UE may or may not be connected to a 3GPP radio access network (RAN) 102, due to a potential network outage, the UE 106 may use a different RAT, such as a Wi-Fi or Bluetooth RAT to communicate the Location Based User Data to the Remote Server 104. The Remote Server 104 can then process the data and, upon detection of a network outage, can send the UE a Network Outage Notification to the UE 106 via the RAT 103, as previously discussed.

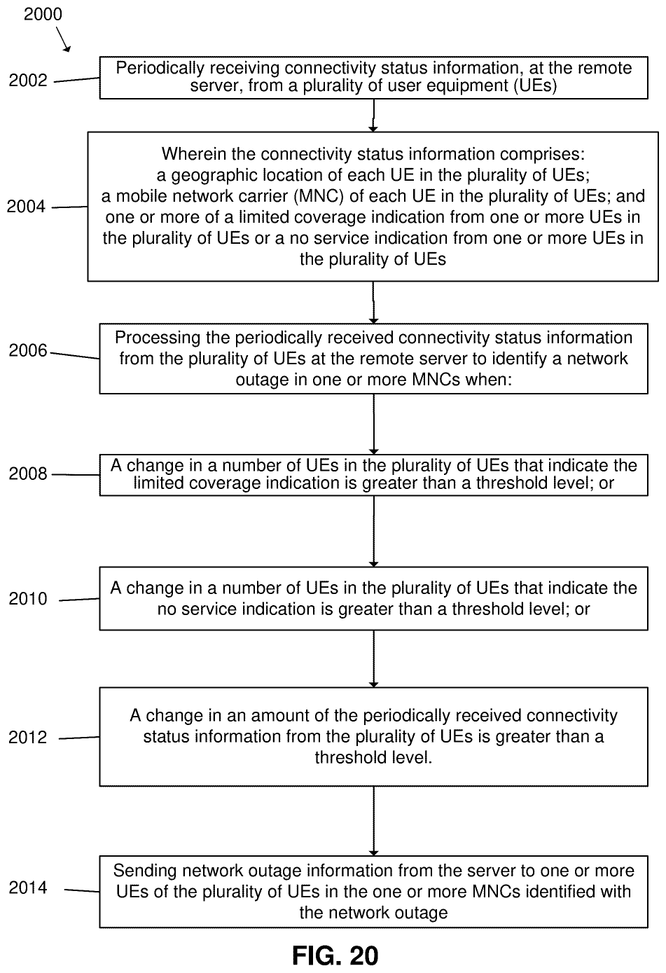

### FIG. 20: Flow Chart for Detecting a Wireless Network Outage at a Remote Server

FIG. 20 illustrates a flow chart of an example of a method 2000 for detecting a wireless network outage at a remote server, according to some embodiments.

The method shown in FIG. 20 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 2000, for detecting a wireless network outage at a remote server is disclosed. The method 2000 comprises periodically receiving connectivity status information, at the remote server, from a plurality of user equipment (UEs), as shown in 2002. The connectivity status information can comprise: a geographic location of each UE in the plurality of UEs; a mobile network carrier (MNC) of each UE in the plurality of UEs; and one or more of a limited coverage indication from one or more UEs in the plurality of UEs or a no service indication from one or more UEs in the plurality of UEs. This information is typically received at a remote server for determining a location of the UEs. However, the information can also be used to determine a network outage.

The method 2000 further comprises processing the periodically received connectivity status information from the plurality of UEs at the remote server to identify a network outage in one or more MNCs, as shown in 2006. The network outage can be identified when: a change in a number of UEs in the plurality of UEs that indicate the limited coverage indication is greater than a threshold level, as shown in 2008; or a change in a number of UEs in the plurality of UEs that indicate the no service indication is greater than a threshold level, as shown in 2010; or a change in an amount of the periodically received connectivity status information from the plurality of UEs is greater than a threshold level, as shown in 2012.

The method 2000 further comprises sending network outage information from the server to one or more UEs of the plurality of UEs in the one or more MNCs identified with the network outage, as shown in block 2014.

In some embodiments, the method 2000 further comprises receiving periodically, at the remote server, a mobile country code (MCC) from the one or more UEs in the plurality of UEs. Sending network outage information further comprises sending information to the one or more UEs to enable the one or more UEs to map a location of the network outage or graphically illustrate a location of the network outage for the one or more MNCs based on the geographic location of the one or more UEs of the plurality of UEs in the one or more MNCs identified with the network outage.

In some embodiments, sending the network outage information further comprises sending an indication to each UE in the one or more MNCs identified with the network outage to reduce, during the network outage, a periodicity of a scan used by the UE to connect to the network to reduce power used by the UE.

In some embodiments, the method 2000 further comprises periodically receiving the connectivity status information from the plurality of UEs at a predefined frequency. In one example, the predefined frequency is one of receiving the connectivity status information, at the remote server, from the plurality of UEs once every 10 minutes, 15 minutes, 20 minutes, 30 minutes, 40 minutes, 45 minutes, 60 minutes, 90 minutes, or 120 minutes. This example is not intended to be limiting. The predefined frequency can be selected to enable the status information to be updated at a desired frequency while minimizing transmissions from the UE to reduce energy usage at the UE.

In some embodiments, a server can be configured to perform any of the operations described in the method 2000.

In some embodiments, a computer program product, comprising computer instructions which, when executed by one or more processors, perform any of the operations described herein.

In some embodiments, the change in the number of UEs in the plurality of UEs that indicate the limited coverage indication is greater than a threshold level is determined based on a change in the connectivity status information at a rate of the predefined frequency; or the change in the number of UEs in the plurality of UEs that indicate the no service indication is greater than a threshold level is determined based on a change in the connectivity status information at a rate of the predefined frequency. The change in the amount of the periodically received connectivity status information from the plurality of UEs is determined based on a change in the amount of the periodically received connectivity status information at a rate of the predefined frequency.

In some embodiments, the change in the number of UEs in the plurality of UEs that indicate the limited coverage indication is greater than a threshold level is determined per MNC; or the change in the number of UEs in the plurality of UEs that indicate the no service indication is greater than a threshold level is determined per MNC; or the change in the amount of periodically received connectivity status information from the plurality of UEs is greater than a threshold level is determined per MNC.

In some embodiments, sending the network outage information further comprises sending, via a radio access technology (RAT), the network outage information from the server to the one or more UEs of the plurality of UEs. The RAT can be one of a third generation partnership project (3GPP) fourth generation (4G) RAT, a 3GPP long term evolution (LTE) RAT, a 3GPP fifth generation (5G) RAT, a Wi-Fi RAT, a Bluetooth RAT, or a Sidelink RAT.

In some embodiments, the method 2000 further comprises sending the network outage information to the one or more UEs of the plurality of UEs based on the geographic location of the UE, wherein the network outage information is sent to UEs in the plurality of UEs in a geographic location where the network outage is identified or to UEs that are approaching the geographic location where the network outage is identified.

In some embodiments, a server is configured to perform any of the operations described in the embodiments of the method 2000.

In some embodiments, a computer program product is disclosed comprising computer instructions which, when executed by one or more processors, perform any of the operations described herein.

Embodiments of the present disclosure may be realized in any of various forms. For example, some embodiments may be realized as a computer-implemented method, a computer readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of detecting a wireless network outage at a remote server, the method comprising:
periodically receiving connectivity status information, at the remote server, from a plurality of user equipment (UEs);
wherein the connectivity status information comprises:
a geographic location of each UE in the plurality of UEs;
a mobile network carrier (MNC) of each UE in the plurality of UEs; and
one or more of a limited coverage indication from one or more UEs in the plurality of UEs or a no service indication from one or more UEs in the plurality of UEs;
processing the periodically received connectivity status information from the plurality of UEs at the remote server to identify a network outage in one or more MNCs when:
a change in a number of UEs in the plurality of UEs that indicate the limited coverage indication is greater than a threshold level; or
a change in a number of UEs in the plurality of UEs that indicate the no service indication is greater than a threshold level; or
a change in an amount of the periodically received connectivity status information from the plurality of UEs is greater than a threshold level; and
sending network outage information from the server to one or more UEs of the plurality of UEs in the one or more MNCs identified with the network outage.

2. The method of claim 1, further comprising receiving periodically, at the remote server, a mobile country code (MCC) from the one or more UEs in the plurality of UEs.

3. The method of claim 1, wherein sending network outage information further comprises sending information to the one or more UEs to enable the one or more UEs to map a location of the network outage or graphically illustrate a location of the network outage for the one or more MNCs based on the geographic location of the one or more UEs of the plurality of UEs in the one or more MNCs identified with the network outage.

4. The method of claim 1, wherein sending the network outage information further comprises sending an indication to each UE in the one or more MNCs identified with the network outage to reduce, during the network outage, a periodicity of a scan used by the UE to connect to the network to reduce power used by the UE.

5. The method of claim 1, further comprising periodically receiving the connectivity status information from the plurality of UEs at a predefined frequency.

6. The method of claim 5, wherein the predefined frequency is one of receiving the connectivity status information, at the remote server, from the plurality of UEs once every 10 minutes, 15 minutes, 20 minutes, 30 minutes, 40 minutes, 45 minutes, 60 minutes, 90 minutes, or 120 minutes.

7. The method of claim 5, wherein:
the change in the number of UEs in the plurality of UEs that indicate the limited coverage indication is greater than a threshold level is determined based on a change in the connectivity status information at a rate of the predefined frequency; or
the change in the number of UEs in the plurality of UEs that indicate the no service indication is greater than a threshold level is determined based on a change in the connectivity status information at a rate of the predefined frequency; or
the change in the amount of the periodically received connectivity status information from the plurality of UEs is determined based on a change in the amount of the periodically received connectivity status information at a rate of the predefined frequency.

8. The method of claim 1, wherein:
the change in the number of UEs in the plurality of UEs that indicate the limited coverage indication is greater than a threshold level is determined per MNC; or
the change in the number of UEs in the plurality of UEs that indicate the no service indication is greater than a threshold level is determined per MNC; or
the change in the amount of periodically received connectivity status information from the plurality of UEs is greater than a threshold level is determined per MNC.

9. The method of claim 1, wherein sending the network outage information further comprises sending, via a radio access technology (RAT), the network outage information from the server to the one or more UEs of the plurality of UEs.

10. The method of claim 9, wherein the RAT is one of a third generation partnership project (3GPP) fourth generation (4G) RAT, a 3GPP long term evolution (LTE) RAT, a 3GPP fifth generation (5G) RAT, a Wi-Fi RAT, a Bluetooth RAT, or a Sidelink RAT.

11. The method of claim 9, further comprising sending the network outage information to the one or more UEs of the plurality of UEs based on the geographic location of the UE, wherein the network outage information is sent to UEs in the plurality of UEs in a geographic location where the network outage is identified or to UEs that are approaching the geographic location where the network outage is identified.

12. An apparatus of a user equipment (UE) comprising:
one or more processors, coupled to a memory, configured to:
identify a location of the UE;
determine a cellular coverage status of the UE as one of connected or limited coverage or no service;
identify a mobile network carrier (MNC) of the UE;
attempt to send, for a selected period of time, to a remote server, connectivity status information of the UE comprising the location of the UE, the cellular coverage status of the UE, and the MNC of the UE;
wherein the remote server is configured to identify a network outage based on the connectivity status of the UE and a connectivity status of a plurality of UEs located in one or more MNCs and send network outage information to the UE and the plurality of UEs associated with one of the one or more MNCs identified with the network outage; and
decode, at the UE, the network outage information received from the remote server when the network outage is identified at the server.

13. The apparatus of the UE of claim 12, wherein the connectivity status information of the UE further comprises one or more of:
a latitude of the UE;
a longitude of the UE;
a speed of the UE;
a direction of the UE;
a radio access technology (RAT) of the UE used to send the connectivity status information; or
a mobile country code (MCC) of the UE.

14. The apparatus of the UE of claim 13, wherein the RAT is one of a third generation partnership project (3GPP) fourth generation (4G) RAT, a 3GPP long term evolution (LTE) RAT, a 3GPP fifth generation (5G) RAT, a Wi-Fi RAT, a Bluetooth RAT, or a Sidelink RAT.

15. The apparatus of the UE of claim 12, wherein the one or more processors are further configured to attempt to send the connectivity status information of the UE to the remote server for a period of a data upload timer.

16. The apparatus of the UE of claim 13, wherein the one or more processors are further configured to:
start a data collection timer prior to identifying the location of the UE;
determine the cellular coverage status of the UE;
determine the location of the UE;
create a data structure comprising the connectivity status information of the UE;
start a data upload timer and a data discard timer;
attempt to upload the connectivity status information after the data upload timer has expired; and
discard the connectivity status information when the data discard timer expires before the connectivity status information is uploaded and start the data collection timer again.

17. The apparatus of the UE of claim 16, wherein the one or more processors are further configured to:
set the data collection timer to a period of one of 5 minutes, 10 minutes, 15 minutes, or 30 minutes;
set the data upload timer to a period of one of 1 minute, 2 minutes, 4 minutes, 6 minutes, or 8 minutes; and
set the data discard timer to a period of one of 2 minutes, 5 minutes, 7 minutes, or 10 minutes.

18. The apparatus of the UE of claim 12, wherein the one or more processors are further configured to:
monitor for the network outage information from the remote server; or
reduce a scan periodicity of the UE to detect a base station in the MNC of the UE when the network outage information is decoded at the UE; or
display an area impacted by the network outage using the network outage information.

19. An apparatus of a server comprising:
one or more processors, coupled to a memory, configured to:
periodically receive connectivity status information, at the server, from a plurality of user equipment (UEs);
wherein the connectivity status information comprises:
a geographic location of each UE in the plurality of UEs;
a mobile network carrier (MNC) of each UE in the plurality of UEs; and
one or more of a limited coverage indication from one or more UEs in the plurality of UEs or a no service indication from one or more UEs in the plurality of UEs;
determine a network connectivity based on the connectivity status information per geographic area, per MNC and per period;
determine a difference of the network connectivity per geographic area and per MNC with a running average of network connectivity over a plurality of periods for the geographic area and the MNC;
declare a network outage when the difference of the network connectivity is greater than a delta connectivity threshold; or
declare a network outage for a geographic area and period when a difference in the no service indication is greater than a delta no service indication threshold level for the geographic area and period; and
send network outage notifications to one or more UEs in the geographic area.

20. The apparatus of the server of claim 19, wherein the connectivity status information for the period is used to update the running average of network connectivity.
